(19) United States
(12) Patent Application Publication
(10) Pub. No.: US 2024/0340811 A1
(43) Pub. Date: Oct. 10, 2024

(54) METHODS AND APPARATUSES FOR POWER CONTROL ENHANCEMENT

(71) Applicant: FG Innovation Company Limited, Tuen Mun (HK)

(72) Inventor: HAI-HAN WANG, Taipei (TW)

(21) Appl. No.: 18/628,799

(22) Filed: Apr. 8, 2024

Related U.S. Application Data
(60) Provisional application No. 63/457,804, filed on Apr. 7, 2023.

(51) Int. Cl. H04W 52/36; H04W 72/1273; H04W 72/232

(52) U.S. Cl. CPC H04W 52/367; H04W 52/365; H04W 72/1273; H04W 72/232

(57) ABSTRACT

Methods and apparatuses for power control enhancement are provided. The method includes determining a first power state based on a first evaluation period; determining a second power state, which is associated with a new transmission, based on a second evaluation period; determining whether a power state change has occurred by comparing the first power state with the second power state; and in response to determining that the power state change for the new transmission has occurred, triggering a Power Headroom Report (PHR) procedure.

### CROSS-REFERENCE TO RELATED APPLICATION(S)

The present disclosure claims the benefit of and priority to U.S. Provisional Patent Application Ser. No. 63/457,804, filed on Apr. 7, 2023, entitled “POWER CONTROL ENHANCEMENTS,” the content of which is hereby incorporated herein fully by reference into the present disclosure for all purposes.

### FIELD

The present disclosure is related to wireless communication and, more specifically, to methods and apparatuses for power control enhancement.

### BACKGROUND

Various efforts have been made to improve different aspects of wireless communication for cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to methods and apparatuses for power control enhancement.

According to a first aspect of the present disclosure, a method performed by a User Equipment (UE) for power control enhancement is provided. The method includes determining a first power state based on a first evaluation period; determining a second power state, which is associated with a new transmission, based on a second evaluation period; determining whether a power state change has occurred by comparing the first power state with the second power state; and in response to determining that the power state change for the new transmission has occurred, triggering a Power Headroom Report (PHR) procedure.

In some implementations of the first aspect of the present disclosure, the method further includes transmitting, to a Base Station (BS), an indication indicating that the UE supports transmissions under a Carrier Aggregation (CA) architecture across different frequency bands with different power classes.

In some implementations of the first aspect of the present disclosure, the method further includes transmitting, to a Base Station (BS), an indication indicating a maximum average percentage of symbols, during an Uplink (UL) duty cycle, that are permitted to be scheduled for a UL transmission at an increased power.

In some implementations of the first aspect of the present disclosure, the method further includes transmitting a PHR using the new transmission in response to triggering the PHR procedure; and starting a prohibit timer in response to transmitting the PHR. The UE is prohibited from transmitting another PHR while the prohibit timer is running.

In some implementations of the first aspect of the present disclosure, the method further includes receiving, from a Base Station (BS), an indication indicating that the UE is allowed to trigger the PHR procedure in response to determining that the power state change has occurred.

In some implementations of the first aspect of the present disclosure, the first evaluation period includes one or more first Uplink (UL) transmissions prior to the new transmission, and the second evaluation period includes the new transmission.

In some implementations of the first aspect of the present disclosure, the first evaluation period further includes a second UL transmission after the new transmission.

In some implementations of the first aspect of the present disclosure, the method further includes receiving, in a Physical Downlink Control Channel (PDCCH) monitoring occasion, a first Downlink Control Information (DCI) format that schedules the new transmission; and receiving, in the same PDCCH monitoring occasion, a second DCI format that schedules the second UL transmission.

According to a second aspect of the present disclosure, a User Equipment (UE) for power control enhancement is provided. The UE includes at least one processor and at least one non-transitory computer-readable medium coupled to the at least one processor. The at least one non-transitory computer-readable medium stores one or more computer-executable instructions that, when executed by the at least one processor, cause the UE to determine a first power state based on a first evaluation period; determine a second power state, which is associated with a new transmission, based on a second evaluation period; determine whether a power state change has occurred by comparing the first power state with the second power state; and in response to determining that the power state change for the new transmission has occurred, trigger a Power Headroom Report (PHR) procedure.

In some implementations of the second aspect of the present disclosure, the one or more computer-executable instructions, when executed by the at least one processor, further cause the UE to transmit, to a Base Station (BS), an indication indicating that the UE supports transmissions under a Carrier Aggregation (CA) architecture across different frequency bands with different power classes.

In some implementations of the second aspect of the present disclosure, the one or more computer-executable instructions, when executed by the at least one processor, further cause the UE to transmit, to a Base Station (BS), an indication indicating a maximum average percentage of symbols, during an Uplink (UL) duty cycle, that are permitted to be scheduled for a UL transmission at an increased power.

In some implementations of the second aspect of the present disclosure, the one or more computer-executable instructions, when executed by the at least one processor, further cause the UE to transmit a PHR using the new transmission in response to triggering the PHR procedure; and start a prohibit timer in response to transmitting the PHR. The UE is prohibited from transmitting another PHR while the prohibit timer is running.

In some implementations of the second aspect of the present disclosure, the one or more computer-executable instructions, when executed by the at least one processor, further cause the UE to receive, from a Base Station (BS), an indication indicating that the UE is allowed to trigger the PHR procedure in response to determining that the power state change has occurred.

In some implementations of the second aspect of the present disclosure, the first evaluation period includes one or more first Uplink (UL) transmissions prior to the new transmission, and the second evaluation period includes the new transmission.

In some implementations of the second aspect of the present disclosure, the first evaluation period further includes a second UL transmission after the new transmission.

In some implementations of the second aspect of the present disclosure, the one or more computer-executable instructions, when executed by the at least one processor, further cause the UE to receive, in a Physical Downlink Control Channel (PDCCH) monitoring occasion, a first Downlink Control Information (DCI) format that schedules the new transmission; and receive, in the same PDCCH monitoring occasion, a second DCI format that schedules the second UL transmission.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a format of a PHR MAC CE, according to an example implementation of the present disclosure.

FIG. 2 is a diagram illustrating multiple evaluation periods for determining the power states of a UE, according to an example implementation of the present disclosure.

FIG. 3 is a diagram illustrating an evaluation period including multiple UL transmissions scheduled by DCI formats received in the same PDCCH monitoring occasion, according to an example implementation of the present disclosure.

FIG. 4 is a diagram illustrating a minimum duration during which a UE remains in a particular power state, according to an example implementation of the present disclosure.

FIG. 5 is a diagram illustrating an evaluation period including a reference time window 54, according to an example implementation of the present disclosure.

FIG. 6 is a diagram illustrating a maximum duration during which the UE is in a particular power state, according to an example implementation of the present disclosure.

FIG. 7 is a flowchart of a method/process for power control enhancement, according to an example implementation of the present disclosure.

FIG. 8 is a block diagram illustrating a node for wireless communication, according to an example implementation of the present disclosure.

### DESCRIPTION

Some of the abbreviations used in this disclosure include:
Abbreviation Full name
3GPP 3^{rd} Generation Partnership Project
5G 5^{th} Generation
5GC 5G Core
ACK Acknowledgement
ACLR Adjacent Channel Leakage Power Ratio
A-CSI Aperiodic Channel State Information
AL Aggregation Level
AN-PDB Access Network Packet Delay Budget
AS Access Stratum
ASN.1 Abstract Syntax Notation One
BA Bandwidth Adaptation
BFRQ Beam Failure Recovery Request
BPSK Binary Phase Shift Keying
BS Base Station
BSR Buffer Status Report
BWP Bandwidth Part
C-RNTI Cell Radio Network Temporary Identifier
CA Carrier Aggregation
CAG Closed Access Group
CAPEX Capital Expenditure
CBGTI Code Block Group Transmission Information
CCE Control Channel Element
CG Configured Grant
CI Cancellation Indication
CJT Coherent Joint Transmission
CN Core Network
CN-PDB Core Network Packet Delay Budget
CORESET Control Resource Set
CP-OFDM Cyclic Prefix Orthogonal Frequency Division Multiplexing
CRC Cyclic Redundancy Check
CSI Channel State Information
CSI-RS Channel State Information Reference Signal
CS-RNTI Configured Scheduling Radio Network Temporary Identifier
CSS Common Search Space
CU Central Unit
DAPS Dual Active Protocol Stack
dBm Decibel Relative to One Milliwatt
DC Dual Connectivity
DCI Downlink Control Information
DFT-s-OFDM Discrete Fourier Transform-spread Orthogonal Frequency Division Multiplexing
DG Dynamic Grant
DI Delay Information
DL Downlink
DL-SCH Downlink Shared Channel
DMRS Demodulation Reference Signal
DR Delay Report
DRB Data Radio Bearer
DTCH Dedicated Traffic Channel
DU Distributed Unit
ETSI European Telecommunications Standards Institute
E-UTRA Evolved Universal Terrestrial Radio Access
EN-DC E-UTRA NR Dual Connectivity
EPC Evolved Packet Core
eMBB Enhanced Mobile BroadBand
eMTC Enhanced Machine Type Communication
eNB Evolved Node B
FCC Federal Communications Commission
FDD Frequency Division Duplexing
FR Frequency Range
FR1 Frequency Range 1
FR2 Frequency Range 2
GEO Geostationary Equatorial Orbit
gNB Next Generation Node B
GNSS Global Navigation Satellite System
GW Gateway
HARQ Hybrid Automatic Repeat Request
HARQ-ACK Hybrid Automatic Repeat Request Acknowledgement
HO Handover
HPS High Power State
FDD Frequency Division Duplexing
FR Frequency Range
IAB Integrated Access and Backhaul
ID Identity
IE Information Element
IoT Internet of Things
IIoT Industrial Internet of Things
ITS Intelligent Transportation System
ITU International Telecommunication Union
L1 Layer 1
L2 Layer 2
L3 Layer 3
LAN Local Area Network
LCG Logical Channel Group
LCH Logical Channel
LCID Logical Channel Identity
LCP Logical Channel Prioritization
LEO Low Earth Orbit
LRR Link Recovery Request
LTE Long Term Evolution
MAC Medium Access Control
MAC CE MAC Control Element
MCG Master Cell Group
MCS Modulation and Coding Scheme
MCS-C-RNTI Modulation Coding Scheme Cell Radio Network Temporary Identifier
MIB Master Information Block
MIMO Multi-Input Multi-Output
mMTC Massive Machine Type Communications
MN Master Node
MPE Maximum Permissible Exposure
MPR Maximum Power Reduction
Msg1 Message 1
Msg2 Message 2
Msg3 Message 3
Msg4 Message 4
MTC Machine Type Communication
NACK Negative Acknowledgement
NAS Non-Access Stratum
NB-IoT Narrow Band Internet of Things
NDI New Data Indicator
NPN Non-Public Network
NPS Nominal Power State
NR New Radio
NR-U NR Unlicensed
NTN Non-Terrestrial Network
NUL Normal Uplink
OFDM Orthogonal Frequency-Division Multiplexing
OPEX Operating Expense
PBCH Physical Broadcast Channel
PC2 Power Class 2
PC3 Power Class 3
PCell Primary Cell
PCI Physical Cell Identity
PDB Packet Delay Budget
PDCCH Physical Downlink Control Channel
PDCP Packet Data Convergence Protocol
PDSCH Physical Downlink Shared Channel
PDU Protocol Data Unit
PHR Power Headroom Report
PH Power Headroom
PHY Physical
PLMN Public Land Mobile Network
P-MPR Power Management Maximum Power Reduction
PNI-NPN Public Network Integrated Non-Public Network
PRACH Physical Random Access Channel
PRB Physical Resource Block
PSDB PDU Set Delay Budget
PTRS Phase Tracking Reference Signal
PUCCH Physical Uplink Control Channel
PUSCH Physical Uplink Shared Channel
QoS Quality of Service
RA Random Access
RA-RNTI Random Access Radio Network Temporary Identifier
RACH Random Access Channel
RAN Radio Access Network
RAPID Random Access Preamble Identifier
RAR Random Access Response
RAT Radio Access Technology
RB Resource Block
Rel-17 Release 17
RF Radio Frequency
RLC Radio Link Control
RS Reference Signal
RLF Radio Link Failure
RSTD Reference Signal Time Difference Measurement
RNTI Radio Network Temporary Identifier
RO RACH Occasion
RRC Radio Resource Control
RS Reference Signal
RSRP Reference Signal Received Power
RSRQ Reference Signal Receiving Quality
RX Reception
SAR Specific Absorption Rate
SCell Secondary Cell
SCG Secondary Cell Group
SDT Small Data Transmission
SDU Service Data Unit
SFI Slot Format Indicator
SFN System Frame Number
SI System Information
SIB System Information Block
SIB1 System Information Block
SL Sidelink
SLIV Start and Length Indicator Value
SN Secondary Node
SNPN Stand-alone Non-Public Network
SpCell Special Cell
SR Scheduling Request
SRB Signaling Radio Bearer
SRS Sounding Reference Signal
SSB Synchronization Signal Block
subPDU Sub Protocol Data Unit
SUL Supplementary Uplink
TA Timing Advance
TAG Timing Advance Group
TAT Time Alignment Timer
TB Transport Block
TBS Transport Block Size
TCI Transmission Configuration Indication
TDD Time Division Duplexing
TDRA Time Domain Resource Allocation
TN Terrestrial Network
TPC Transmit Power Control
TRP Transmission Reception Point
TRS Tracking Reference Signal
TS Technical Specification
TX Transmission
UCI Uplink Control Information
UE User Equipment
UL Uplink
UL-CG Uplink-Configured Grant
UL-SCH Uplink Shared Channel
UPF User Plane Function
UPI Unused Physical Uplink Shared Channel Indication
URLLC Ultra-Reliable and Low-Latency Communications
USIM Universal Subscriber Identity Module
USS UE-specific Search Space
V2X Vehicle-to-Everything
VSAT Very Small Aperture Terminal
XR Extended Reality

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, or at least one of A and B.

The terms, definitions, and abbreviations included in the present disclosure are either sourced from existing documents (such as those from ETSI, ITU, or other sources) or newly created by experts from the 3GPP whenever there was a need for a precise vocabulary.

Examples of some selected terms in the present disclosure are provided as follows. BWP: A subset of the total bandwidth of a cell may be referred to as a BWP. A Bandwidth Adaptation (BA) may be achieved by configuring the UE with one or more BWPs and indicating to the UE which BWP is currently active. To enable the BA on the PCell, the gNB may configure the UE with at least one UL BWP and/or at least one DL BWP. To enable the BA on an Scells (e.g., in a CA), the gNB may configure the UE with at least one DL BWP and at least one UL BWP. The initial BWP for the Pcell may be the BWP used for the initial access, while for Scells, the initial BWP may be the BWP configured for the UE to first operate upon an Scell activation. The UE may be configured with a first active UP BWP through an information element (IE), such as a firstActiveUplinkBWP IE. If the first active UL BWP is for an SpCell, the firstActiveUplinkBWP IE field may contain the ID of the UL BWP to be activated when the RRC (re-)configuration is performed. If the firstActiveUplinkBWP IE field is absent, the RRC (re-)configuration does not impose a BWP switch. If the first active UL BWP is for an Scell, the firstActiveUplinkBWP IE field may contain the ID of the UL BWP to be used upon a MAC-activation of an Scell.

In-band emission: In-band emission may refer to the average emission across 12 sub-carriers and as a function of the RB offset from the edge of the allocated UL transmission bandwidth. The in-band emission may be measured as the ratio of the UE output power in a non-allocated RB to the UE output power in an allocated RB.

Out of band emission: Out of band emission may refer to unwanted emissions immediately outside the assigned channel bandwidth resulting from the modulation process and non-linearity in the transmitter but excluding spurious emissions. This out of band emission limit may be specified in terms of a spectrum emission mask and an adjacent channel leakage power ratio.

Adjacent channel leakage ratio: Adjacent Channel Leakage Power Ratio (ACLR) may refer to the ratio of the filtered mean power centred on the assigned channel frequency to the filtered mean power centred on an adjacent channel frequency.

In the present disclosure, although the term “gNB” is used throughout the document, it should be understood that the term “gNB” can be replaced by any other type of BS.

### General Aspects

### SSB

An SSB is used by the UE for DL synchronization and to measure the signal strength of a cell. Multiple SSBs may be transmitted by a gNB, and each SSB may be transmitted via different beams. An SSB may carry an MIB including the configuration of CORESET 0 and search space 0, which are used for scheduling the SIB1. The SIB1 may carry configurations related to cell selection and initial access, such as PRACH resource configuration. The UE may evaluate the measured results based on the configurations in the SIB1 to determine whether to camp on the cell and perform initial access. During the initial access, the initial DL BWP include the PRBs that contain CORESET 0. The initial DL BWP may be used for receiving RACH procedure related DL messages, such as the RAR, Msg4, and/or other messages before a dedicated DL BWP is configured by gNB. The initial DL BWP may also be used for receiving system information and paging messages. Specifically, a Type-1 common search space may be configured by the SIB1 to be associated with CORESET 0 or a CORESET configured by an IE, such as the commonControlResourceSet IE, for receiving DCI that schedules the RAR, the Msg4, and/or other messages before a dedicated DL BWP is configured by gNB. A Type-2 common search space may be configured by the SIB1 to be associated with CORESET 0 or a CORESET configured by the commonControlResourceSet IE for receiving DCI that schedules the paging messages. After the initial access, the initial DL BWP may be defined as the PRBs configured by the initial DL BWP configuration carried in the SIB1, if configured. Otherwise, the initial DL BWP may be the same as that used during the initial access. On the other hand, during and after the initial access, the initial UL BWP may include the PRBs that are configured by the initial UL BWP configuration, for example, carried by the SIB1.

### PRACH

In Release 15, the PRACH resources for initial access may be configured by the SIB1. Specifically, the initial UL BWP configuration provided by the SIB1 may include a particular IE, such as the BWP-UplinkCommon IE, which includes the RACH-ConfigCommon IE used to configure the PRACH resources. For the RRC connected UEs, the PRACH resources may also be configured in other UL BWPs, and the UE may use the PRACH resources when the UL BWP with the PRACH resources is the active UL BWP.

### PDCCH

In NR, a gNB may transmit the DCI to a UE via a PDCCH using one or more CCEs in a CORESET. The configurations of a CORESET may include (1) the configuration of the PRBs of which the frequency domain resource is used for the CORESET and/or (2) the configuration of the number of OFDM symbols defining the time duration of the CORESET. One or more search spaces may be associated with a CORESET. One occasion of the CORESET may be referred to as a monitoring occasion. The configurations of a search space may include the configuration of the periodicity and time offset of the search space, as well as the configuration of the duration of the search space (e.g., the consecutive number of slots in which one or more monitoring occasions exist). If the duration is configured as one, there is only one slot in which the monitoring occasion(s) exists in each period. The configurations of a search space may also include the configuration of the type of the search space (e.g., USS or CSS) and the DCI format(s) that are monitored within the search space. Additionally, the configurations of a search space may include the number of PDCCH candidates per Aggregation Level (AL). It should be noted that a search space may also be referred to as a search space set. Once configured with the CORESET(s) and the search space(s), the UE may attempt to decode the PDCCH candidates based on the configurations, a process that may also be referred to as PDCCH monitoring.

### DCI Formats Monitored in a Search Space

Possible combinations of the DCI formats monitored in a USS may include {DCI format 0_0, DCI format 1_0}, {DCI format 0_1, DCI format 1_1}, {DCI format 0_2, DCI format 1_2}, and {DCI format 0_1, DCI format 1_1, DCI format 0_2, DCI format 1_2}. Notably, DCI formats 0_0, 0_1, and 0_2 are for scheduling PUSCH, while DCI formats 1_0, 1_1, and 1_2 are for scheduling PDSCH. In a USS, the CRC of a DCI format may be scrambled by a C-RNTI, a CS-RNTI, or an MCS-C-RNTI. If the CRC of a DCI format 0_0, 0_1, or 0_2 is scrambled by a CS-RNTI, the PUSCH transmission scheduled by this DCI format is a retransmission of a CG PUSCH if the NDI field of the DCI format is set to 1.

### Configured Grant

In NR, a UE in RRC_CONNECTED state may be provided with one or more Configured Grants (CG). The CG may be a Type-1 CG or a Type-2 CG. For a Type-1 CG, the UE may directly use the CG for UL transmissions after receiving the CG configuration. For a Type-2 CG, the UE may not directly use the CG for UL transmissions after receiving the CG configuration. To use the CG for a UL transmission, the UE needs to receive activation DCI which activates the CG. Specifically, the activation DCI may include a DCI format 0_0, DCI format 0_1, or DCI format 0_2 with CRC scrambled by a CS-RNTI, and the NDI field of the DCI format may be set to 0. A CG configuration may include one or more of the following configurations: time domain symbol allocation, frequency resource allocation, DMRS configuration, Modulation and Coding Scheme (MCS), periodicity, the number of repetitions, the number of HARQ processes, transform precoding.

PUSCH occasions configured by the CG occur periodically in the time domain with the configured periodicity. Within each period, there are PUSCH occasions in consecutive slots when the number of repetitions is greater than 1, and the number of consecutive slots is equal to the number of repetitions. That is, one slot contains one PUSCH occasion which may be used for one repetition, and each PUSCH occasion may have the same symbol allocation. The HARQ process ID for a PUSCH occasion may be determined based on the SFN and the slot number corresponding to the slot where the PUSCH occasion is located.

Coverage may be one of the key factors that an operator may consider when commercializing cellular communication networks due to its direct impact on service quality as well as CAPEX and OPEX. UL performance may become the bottleneck in most scenarios in real deployments, while there may be emerging vertical use cases that have UL heavy traffic, e.g., video uploading. In the Rel-17 work item “NR Coverage Enhancements,” NR coverage has been extended for some of the bottleneck channels identified in the Rel-17 study item “Study on NR coverage enhancements,” in particular for PUSCH, PUCCH, and Msg3 transmissions. Increasing UE power high limit for CA and DC may fully utilize the UE power high ability in each TX chain, without a high limit cap.

### Power Control

The characteristics of the DFT-s-OFDM waveform may result in less MPR compared to the CP-OFDM waveform, where MPR may refer to the allowed maximum amount of power reduction relative to the UE maximum output power in order to meet requirements such as in-band emission, out-of-band emission, etc. The MPR of the DFT-s-OFDM waveform may be smaller than the MPR of the CP-OFDM waveform for a given modulation order. The MPR may be larger for a higher modulation order for a given waveform. The transmission power of a UL transmission may not exceed a configured maximum output power (e.g., as defined in 3GPP TS 38.101 V18.0.0 and/or the subsequent version(s)). Specifically, the UE may be allowed to set its configured maximum output power P_{CMAX,f,c} for a carrier f of a serving cell c in each slot. The configured maximum output power P_{CMAX,f,c} may be set within P_{CMAX_L,f,c}≤P_{CMAX,f,c}≤P_{CMAX_H,f,c}, where P_{CMAX_H,f,c} and P_{CMAX_L,f,c} may increase as the UE maximum output power increases, and P_{CMAX_L,f,c} may also increase as the MPR decreases. The UE maximum output power may depend on the power class of the UE. For example, the UE maximum output power may be 23 dBm for a UE of a PC3, and the UE maximum output power may be 26 dBm for a UE of a PC2. For a UE of a PC3, if the UE is operating in TDD bands n40, n41, n77, n78, or n79 with a π/2 BPSK modulation (using the DFT-s-OFDM waveform) and the UE indicates support for the UE capability powerBoosting-pi2BPSK and 40% or less symbols in a certain evaluation period are used for a UL transmission, the UE maximum output power may be 26 dBm.

The PUSCH transmission power may be determined as follows: if a UE transmits a PUSCH on an active UL BWP b of a carrier f of a serving cell c using a parameter set configuration with an index j and a PUSCH power control adjustment state (also referred to as PUSCH power control loop) with an index l, the UE may determine the PUSCH transmission power P_{PUSCH,b,f,c}(i, j, q_{d}, l) in a PUSCH transmission occasion i as P_{PUSCH,b,f,c}(i, j, q_{d}, l)=min{P_{CMAX,f,c}(i), P_{O_PUSCH,b,f,c}(i)+10 log₁₀ (2^{μ}·M_{RB,b,f,c}^{PUSCH}(i))+α_{b,f,c} (j). PL_{b,f,c}(q_{d})+Δ_{TF,b,f,c}(i)+f_{b,f,c}(i, l)} [dBm], where
P_{CMAX,f,c}(i) may refer to the UE configured maximum output power for the carrier f of the serving cell c in the PUSCH transmission occasion i,
P_{O_PUSCH,b,f,c}(i) may refer to a parameter composed of the sum of a component P_{O_NOMINAL_PUSCH,f,c}(i) (also referred to as nominal P0) and a component P_{O_UE_PUSCH,b,f,c}(i) (also referred to as (UE-dedicated) P0),
f_{b,f,c} (i, l) may refer to the PUSCH power control adjustment state l for the active UL BWP b of the carrier f of the serving cell c and the PUSCH transmission occasion i. The value of f_{b,f,c} (i, l) may be indicated by one or more TPC commands carried by a DCI format 0_0, a DCI format 0_1, a DCI format 0_2, or a DCI format 2_2. If the accumulation of the TPC commands is configured, the value of f_{b,f,c} (i, l) may be the sum of all TPC commands received before a processing time before the PUSCH transmission occasion i. If the accumulation of the TPC commands is not configured, the value of f_{b,f,c} (i, l) may be the TPC command received via the DCI format 0_0, the DCI format 0_1, or the DCI format 0_2 that schedules the PUSCH transmission occasion i. Definitions of other parameters mentioned in the above equation related to P_{PUSCH,b,f,c} (i, j, q_{d}, l) may be referenced in 3GPP TS 38.213 V18.1.0 and/or the subsequent version(s).

### PHR Procedure

When a PHR procedure is triggered, if a UE determines that a Type 1 PHR for an activated serving cell is based on an actual PUSCH transmission, then, for a PUSCH transmission occasion i on an active UL BWP b of a carrier f of a serving cell C, the UE may determine the Type 1 PHR as

$${P}_{CMAX , f , c} ( i ) - \{ {P}_{{O}_{PUSCH} , b , f , c} ( i ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} .$$

A periodic PHR procedure may be triggered when a timer, such as phr-Periodic Timer, expires. The phr-Periodic Timer may be restarted after a PHR transmission.

An aperiodic PHR may be triggered when a pathloss changes. For example, a PHR procedure may be triggered if the phr-ProhibitTimer expires or has expired and the path loss has changed more than a particular value, such as phr-Tx-PowerFactorChange dB, for at least one RS used as a pathloss reference for an activated serving cell of any MAC entity of which the active DL BWP is not a dormant BWP since the last transmission of a PHR in the MAC entity when the MAC entity has UL resources for a new transmission.

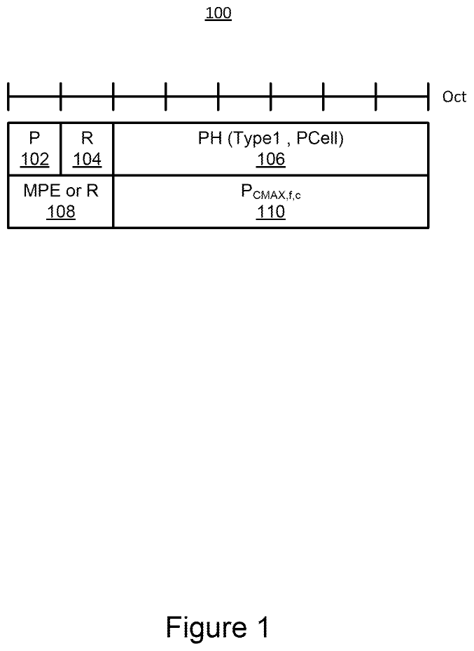

In some implementations, a PHR MAC CE may be used to include a PHR. An example is shown in FIG. 1.

FIG. 1 is a diagram illustrating a format of a PHR MAC CE 100, according to an example implementation of the present disclosure. As illustrated in FIG. 1, the PHR MAC CE 100 may be a single entry PHR MAC CE that may include the fields 102, 104, 106, 108, and 110. The field 102 may include a P bit that indicates whether the P-MPR is applied. The field 104 may include an R bit (e.g., a reserved bit). The field 106 may indicate a PH value (e.g., for a Type 1 PHR to a PCell). The field 108 may indicate an applied power backoff for an MPE requirement or may be represented as reserved bits. The field 110 may indicate the value of the maximum output power P_{CMAX,f,c}.

### MPE

The MPE may be regulated by different organizations, such as the FCC, to ensure that the maximum RF exposure that may be experienced by a human body does not exceed a certain value. The MPE may be defined in terms of a time-averaged value.

### SAR

The SAR may refer to a measure of the rate of the RF energy absorption by the body from the source being measured, which may be regulated by different organizations, such as the FCC. The SAR limit may be defined in terms of a time-averaged value.

### P-MPR

The P-MPR may refer to a power management maximum power reduction for a) ensuring compliance with the applicable electromagnetic energy absorption requirements and addressing the unwanted emissions/self-desense requirements in a case of simultaneous transmissions on multiple RATs for scenarios not included in the scope of 3GPP RAN specifications, or b) ensuring compliance with the applicable electromagnetic energy absorption requirements in a case that proximity detection is used to address such requirements that require a lower maximum output power.

The P-MPR may be reported via a PHR. For example, the MPE field in a single entry PHR MAC CE (e.g., the field 108 in the PHR MAC CE 100) may indicate the P-MPR, as described below. If the UE is configured with a particular IE, such as the mpe-Reporting-FR2 IE, and the serving cell operates on the FR2, and if the P field (e.g., the field 102 in the PHR MAC CE 100) is set to 1, the MPE field may indicate the applied power backoff to meet the MPE requirements. For example, the MPE field may indicate an index to Table 6.1.3.8-3 in TS 38.101-2 Vxx.x.x, and the corresponding measured values of the P-MPR levels in dB may be specified in TS 38.133 Vxx.x.x. As illustrated in FIG. 1, the length of the MPE field may be 2 bits. If the UE is not configured with the mpe-Reporting-FR2 IE, or if the serving cell operates on the FR1, or if the P field is set to 0, R bits may be present in the MPE field instead.

Typically, a UE may use a dedicated set of power amplifiers to support the transmission in a (frequency) band. The maximum power a UE may transmit in a band may be governed by its power class. When operating across more than one band, although the UE may be able to theoretically deliver maximum power across each of the bands in a band combination, the maximum total power a UE may deliver may be governed by the power class associated with that band combination. For example, a UE may declare itself as a PC3 UE (e.g., with the maximum output power of 23 dBm) in a band X and a band Y, and as a PC3 UE for the band combination X & Y. The declaration of a UE as PC3 for the band combination X & Y may be less about the UE's own power capabilities and more about regulatory or specification constraints. Specifically, the specification set by the RAN4 committee might only permit certain power classes for specific band combinations. Therefore, even if a UE is capable of using an increased power across each band individually, the combined operation in bands X and Y may be limited to a PC3 classification due to the regulatory or specification constraints. This may unnecessarily limit such a UE on transmitting at the combined maximum power for the specific band combination. To address this issue, a new UE capability indicated via a particular IE, such as the highPowerLimit-r17 IE, may be introduced, and when the UE capability is signalled for a band combination where one band supports up to the PC3 and another band supports up to the PC2, the total power (P_{CMAX_H} as described below) associated with the band combination may be assumed to be the sum of the individual power classes (e.g., 27.8 dBm).

A UE capability regarding the maximum UL duty cycle may be reported via a particular IE, such as the max UplinkDutyCycle-interBandCA-PC2 IE, for a band combination for which the highPowerLimit-r17 IE is indicated. The maxUplinkDutyCycle-interBandCA-P (2 IE may indicate the maximum average percentage of symbols during a certain evaluation period (also referred to as a UL duty cycle) that may be scheduled for a UL transmission using increased power so as to ensure compliance with the applicable electromagnetic energy absorption requirements provided by regulatory bodies.

The average percentage of (UL) symbols may be defined as 50%×(Duty_{NR,x}/maxDuty_{NR,x}+Duty_{NR,y}/maxDuty_{NR,y}), where
Duty_{NR,x} and Duty_{NR,y} may represent the actual percentage of (UL) symbols transmitted in the same evaluation period (e.g., the exact evaluation period may not be less than one radio frame) for an NR band x and an NR band y, respectively,
The maxDuty_{NR,x} and maxDuty_{NR,y} may represent the field of UE capability maxUplinkDutyCycle-PC2-FR1 per band, as defined in TS 38.331 V18.0.0.

In some implementations, for the NR band x or the NR band y, if the power class of one or both of the bands within the band combination is a PC2 and the corresponding UE capability maxUplinkDutyCycle-PC2-FR1 is absent in a UE capability message, each of the corresponding maxDuty_{NR,x} or maxDuty_{NR,y} may be equal to 50%. Otherwise, if the band is configured with a PC3, each of the corresponding maxDutyNR,x or maxDutyNR,y may be equal to 100%.

If the maxUplinkDutyCycle-interBandCA-PC2 IE is absent, the UE may apply the increased power regardless of the UL duty cycle, and the UE may use the P-MPR, as defined in Section 6.2.4 of TS 38.101-1 V18.0.0, if necessary. If the UE indicates the max UplinkDutyCycle-interBandCA-PC2 IE, and the average percentage of symbols during a certain evaluation period is larger than the value indicated by the maxUplinkDutyCycle-interBandCA-PC2 IE, the UE may operate in an NPS, in which the UE may not be able to use the increased power for transmissions. Conversely, if the UE indicates the maxUplinkDutyCycle-interBandCA-PC2 IE, and the average percentage of symbols during a certain evaluation period is not larger than the value indicated by the maxUplinkDutyCycle-interBandCA-PC2 IE, the UE may operate in an HPS, in which the UE may use the increased power for transmissions.

For the UL carrier aggregation, the UE may be allowed to set its configured maximum output power P_{CMAX,c} for a serving cell c and its total configured maximum output power P_{CMAX}.

The total configured maximum output power P_{CMAX} may be set within the bounds of P_{CMAX_L}, and P_{CMAX_H}. That is,
P_{CMAX_L}≤ P_{CMAX}≤P_{CMAX_H}.

For the UL inter-band carrier aggregation with a serving cell c per operating band, when the same slot symbol pattern is used in all aggregated serving cells,

P_{CMAX_L}=MIN{10 log₁₀ΣMIN[P_{EMAX,c}/(Δt_{C,c}),p_{PowerClass,c}/(MAX(mpr_{c′}Δmpr_{c},a-mpr_{c})·Δt_{C,c}·Δt_{IB,c}·Δt_{RxSRS,c}),p_{PowerClass,c}/pmpr_{c}],P_{EMAX,CA},P_{PowerClass,CA}}, and

P_{CMAX_H}=MIN{10 log₁₀ΣP_{EMAX,c},P_{EMAX,CA},P_{PowerClass,CA}}.

P_{PowerClass,CA} may refer to the maximum UE power, as specified in Table 6.2A.1.3-1 of TS 38.101-1 V18.0.0 without taking into account the tolerance, as specified in Table 6.2A.1.3-1 of TS 38.101-1 V18.0.0. If the UE indicates the highPowerLimit-r17 IE for an eligible CA configuration and ΔP_{PowerClass,CA}=0, P_{PowerClass,CA} may be replaced by 10 log₁₀Σp_{PowerClass,c}.

p_{PowerClass,c} may refer to the linear value of the maximum UE power for serving cell c, as specified in Table 6.2.1-1 of TS 38.101-1 V18.0.0, according to a particular IE, such as the ue-PowerClassPerBandPerBC-r17 IE, if indicated, or another particular IE, such as the ue-PowerClass IE, otherwise, without taking into account the tolerance.

ΔP_{PowerClass,CA} may be 3 dB for a PC2-capable UE when the requirements of the default power class are applied, as specified in sub-clause 6.2.A.1.3 of TS 38.101-1 V18.0.0; otherwise ΔP_{PowerClass,CA} may be 0 dB.

Definitions of other parameters mentioned in the equations related to P_{CMAX_L}, and P_{CMAX_H} may be referenced in the 3GPP TS 38.101-1 V18.0.0 and/or the subsequent version(s).

The HPS may correspond to the case where the UE may replace P_{PowerClass,CA} by 10 log₁₀ Σp_{PowerClass,c} when determining the bounds of P_{CMAX_L}, and P_{CMAX_H}, and the NPS may correspond to other cases.

To enable the gNB to schedule the UE with the increased total power, the gNB may need to know whether the UE operates in the HPS. Whether the UE is in the HPS may depend on whether the average percentage of (UL) symbols transmitted in a certain evaluation period is not larger than the duty cycle indicated by the maxUplinkDutyCycle-interBandCA-PC2 IE. However, since the gNB may not know the certain evaluation period, the gNB may not know the power state of the UE. If the gNB schedules the UE with the increased total power when the UE is not in the HPS, the P-MPR may be used by the UE. Additionally, a UL transmission may not be set with a proper MCS by the gNB, making the UL transmission more likely to fail.

To address the issues described above, the present disclosure provides various mechanisms/methods/approaches for the power control enhancement.

When a UE is configured with two or more serving cells with a band combination for which the highPowerLimit-r1 IE and the maxUplinkDutyCycle-interBandCA-PC2 IE are reported by the UE, the UE may apply a new PHR triggering mechanism. In some implementations, whether the new PHR triggering mechanism should be used may be configured by the gNB.

When the new PHR triggering mechanism is applied, the PHR procedure may be triggered when the power state of the UE changes, e.g., from the HPS to the NPS, or from the NPS to the HPS. A timer, such as the phr-ProhibitTimer or another predetermined timer, may be used to prohibit the UE from triggering a PHR procedure. To prevent a temporary power state change from triggering a PHR procedure, the present disclosure provides the following mechanisms (e.g., mechanism 1 to mechanism 3). It should be noted that in the present disclosure, a new transmission may refer to a transmission that occurs for the first time a TB is transmitted. In other words, the new transmission is not a repetition or a retransmission of a previous transmission. Additionally, the terms “new transmission” and “new UL transmission” may be used interchangeably in the present disclosure.

### Mechanism 1

In this mechanism, a PHR procedure may be triggered when the MAC entity has a UL resource for a new transmission and the power state changes for the new transmission compared to the last UL transmission, where the new transmission may be used to transmit the PHR. In other words, a first power state evaluated based on a first evaluation period that includes the last UL transmission may differ from a second power state evaluated based on a second evaluation period that includes the new transmission.

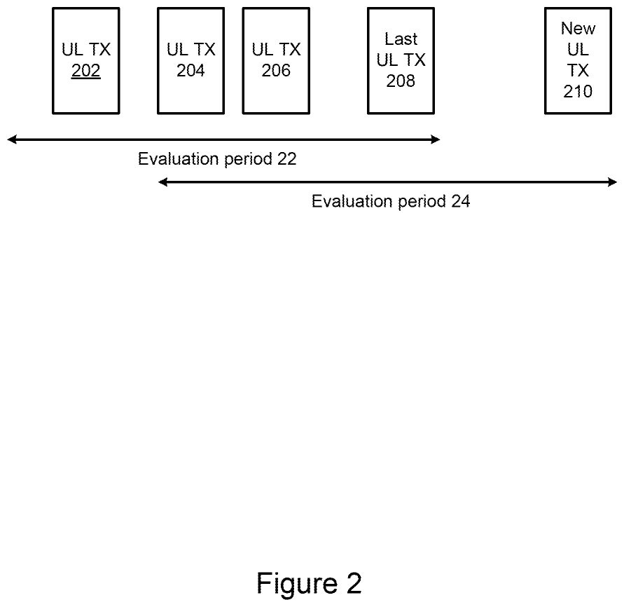

FIG. 2 is a diagram illustrating multiple evaluation periods 22 and 24 for determining the power states of a UE, according to an example implementation of the present disclosure. As illustrated in FIG. 2, the evaluation period 22 may include several UL transmissions, including a UL transmission 202 (denoted as “UL TX” in the figures), a UL transmission 204, a UL transmission 206, and a UL transmission 208, where the UL transmission 208 is the last UL transmission before the new UL transmission 210. The evaluation period 24 may include a new UL transmission 210. In addition to the new UL transmission 210, the evaluation period 24 may also include one or more UL transmissions, such as the UL transmissions 204, 206, and 208. If a first power state, which is evaluated by the UE based on the evaluation period 22, is an NPS, and a second power state, which is evaluated by the UE based on the evaluation period 24 that includes the new UL transmissions 210, is an HPS, then the UE may determine that a power state change has occurred and may trigger a PHR procedure to transmit a PHR in the new UL transmissions 210.

In some implementations, an evaluation period that includes the new UL transmission may further include one or more UL transmissions that occur after the PUSCH transmission (e.g., the new UL transmission) carrying the PHR. For example, the UL transmissions included in such an evaluation period may include one or more UL transmissions scheduled by the DCI formats received before the DCI format scheduling the new UL transmission and/or the DCI format(s) received in the same PDCCH monitoring occasion in which the DCI format scheduling the new UL transmission is received.

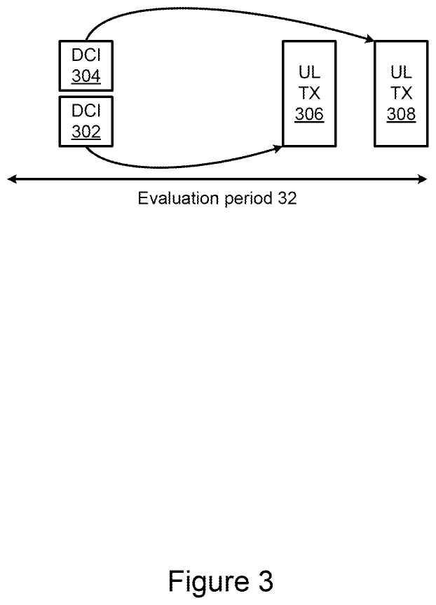

FIG. 3 is a diagram illustrating an evaluation period 32 including multiple UL transmissions scheduled by DCI formats received in the same PDCCH monitoring occasion, according to an example implementation of the present disclosure. As illustrated in FIG. 3, the DCI format 302 and the DCI format 304 may be received in the same PDCCH monitoring occasion. Furthermore, the UL transmission 306 is scheduled by the DCI format 302 and the UL transmission 308 is scheduled by the DCI format 304, where the UL transmission 306 is a new UL transmission for carrying the PHR. In this situation, the evaluation period 32 that includes the new UL transmission (e.g., the UL transmission 306) may further include the UL transmission 308.

### Mechanism 2

In this mechanism, a PHR procedure may be triggered when the MAC entity has a UL resource for a new transmission and the power state for the new transmission has changed compared to the last reported power state, where the new transmission may be used to carry the PHR. In other words, a first power state, which is indicated in the last PHR, may be different from a second power state evaluated based on an evaluation period that includes the new transmission. In some implementations, such an evaluation period may include the UL transmissions that occur after the PUSCH carrying the PHR (e.g., the new transmission). The UL transmissions included in the evaluation period may include (or may consist of) the UL transmissions scheduled by the DCI formats received before the DCI format that schedules the new transmission or the DCI formats received in the same PDCCH monitoring occasion as the DCI format that schedules the new transmission. For example, as illustrated in FIG. 3, as the DCI format 302 and the DCI format 304 are received in the same PDCCH monitoring occasion, and the new UL transmission 306 is scheduled by the DCI format 302, and the UL transmission 308 is scheduled by the DCI format 304, the evaluation period 32 may include the UL transmission 308 in addition to the UL transmission 306.

### Mechanism 3

In this mechanism, a PHR procedure may be triggered when the MAC entity has a UL resource for a new transmission and the power state has changed based on a first evaluation period compared to the last reported power state, where the new transmission may be used to carry the PHR. The first evaluation period may or may not include the new transmission. The PHR procedure may be cancelled if the power state changes again based on a second evaluation period that includes the new transmission. In some implementations, if a PHR procedure is triggered by an existing condition (e.g., a path loss change greater than a particular threshold), the power state of the UE may be indicated in the PHR, and the power state may be determined based on an evaluation period that includes the new transmission carrying the PHR.

In some implementations, for the mechanisms described above (e.g., mechanisms 1 to 3), if there is one or more repetitions of the new transmission, the evaluation period that includes the new transmission may further include, at least, part of the repetition(s).

In some implementations, for the mechanisms described above (e.g., mechanisms 1 to 3), the UE may be assumed to be in an HPS after receiving an RRC configuration that configures two or more serving cells associated with the band combination.

### Time Duration in a Power State

In some implementations, a timer may be used to trigger a second PHR procedure following a first PHR procedure, where the first PHR procedure may be triggered due to a power state change (e.g., based on mechanisms 1 to 3 described above). The second PHR procedure may be used to update the remaining time duration of the indicated power state in a first PHR transmitted in the first PHR procedure. If an indicated time duration is determined based on one or more assumptions that are not aligned with the gNB's, the indicated time duration may not be accurate. That is, a power state change may occur before, or after, the end of the indicated time duration. Therefore, the timer may be started after the transmission of the first PHR, and the second PHR procedure may be triggered when the timer expires. The duration of the timer may be configured by the gNB, or the UE may set the duration of the timer based on the indicated time duration in the first PHR.

In some implementations, a PHR may indicate the power state of a UE, e.g., an HPS or an NPS. If the indicated power state is an NPS, the PHR may also indicate a minimum duration during which the UE remains in the NPS. This minimum duration may represent a period during which the UE remains in the NPS after the end of the new transmission carrying the PHR, assuming that no UL transmissions have occurred during this duration, with certain exceptions, as described in the following.

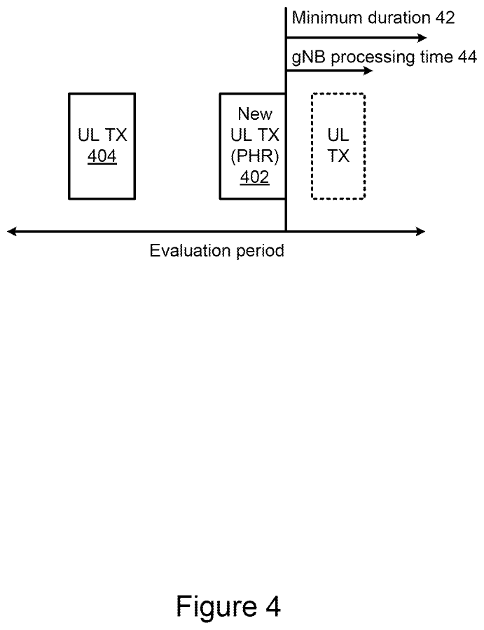

FIG. 4 is a diagram illustrating a minimum duration 42 during which a UE remains in a particular power state (e.g., an NPS), according to an example implementation of the present disclosure. The minimum duration 42 may be determined based on one or more particular assumptions. As illustrated in FIG. 4, the PHR may be carried by the new UL transmission 402 following the UL transmission 404. Since the gNB may need some time to process the PHR, and may have allocated one or more UL transmissions after the new UL transmission 402 before becoming aware of a power state change, the assumptions regarding whether there are UL transmissions and how many UL transmissions are within the gNB processing time 44 may need to be aligned between the gNB and the UE.

In some implementations, the UE may assume that there are no UL transmissions within the gNB processing time 44. In some implementations, the UE may assume that there is one or more UL transmissions (e.g., represented by a dashed rectangle in FIG. 4) in all the UL symbols in all the serving cells within the gNB processing time 44. In some implementations, the UE may assume that there is one or more UL transmissions (e.g., represented by a dashed rectangle in FIG. 4) in all the UL symbols in only one serving cell within the gNB processing time 44, where the one serving cell may be predefined or configured by the gNB. For example, the serving cell may be a serving cell that has the smallest serving cell index.

The UL transmission(s) following the new UL transmission 402 carrying the PHR may be considered when determining the minimum duration 42. For example, the configured UL transmissions or the UL transmissions scheduled by (1) the DCI formats received before the DCI format scheduling the new UL transmission 402 carrying the PHR and/or (2) the DCI format received in the same PDCCH monitoring occasion as the DCI format scheduling the new UL transmission 402 may be considered when determining the minimum duration 42. In some implementations, if UL skipping is configured, the scheduled or configured UL transmissions may be assumed, as not to be skipped when determining the minimum duration 42.

In some implementations, if the power state indicated by the PHR is an HPS, the PHR may further indicate a maximum average percentage of (UL) symbols that may be transmitted in a certain time period, so as to allow the UE to remain in the HPS. For example, a reference time window may be predefined, configured by the gNB, or indicated by the UE via a UE capability report or via the PHR. This reference time window may start immediately after the end of the new transmission for the PHR, or may begin after an offset from the end of the new transmission for the PHR.

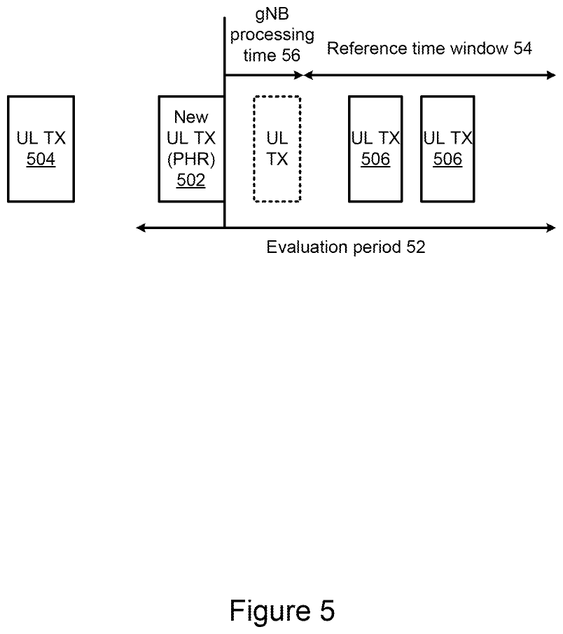

FIG. 5 is a diagram illustrating an evaluation period 52 including a reference time window 54, according to an example implementation of the present disclosure. As illustrated in FIG. 5, one or more UL transmissions 506 may be scheduled or configured in the time reference window 54, so that the average percentage of (UL) symbols within the evaluation period 52 (e.g., including the time reference window 54) may not exceed a particular value (e.g., indicated by an IE, such as the max UplinkDutyCycle-interBandCA-P2 IE).

The PHR may be carried by the new UL transmission 502 following the UL transmission 504. Given that the gNB may need some time to process the PHR, the gNB may allocate some UL transmissions after the new UL transmission 502 before becoming aware of a power state change. Therefore, the assumptions regarding whether there are UL transmissions and how many UL transmissions are within the gNB processing time 56 may need to be aligned between the gNB and the UE.

In some implementations, the reference time window 54 may refer to a time offset that is larger than the gNB processing time 56, enabling the information of the maximum average percentage of (UL) symbols that may be transmitted in the reference time window 54 to be better utilized by the gNB. In some implementations, the UE may assume that there are no UL transmissions within the gNB processing time 56. In some implementations, the UE may assume that there are one or more UL transmissions (e.g., represented by a dashed rectangle in FIG. 5) in all the UL symbols in all the serving cells. In some implementations, the UE may assume that there is one or more UL transmissions (e.g., represented by a dashed rectangle in FIG. 5) only in one serving cell within the gNB processing time 56, where the serving cell may be predefined or configured by the gNB (e.g., a serving cell that has the smallest serving cell index).

The UL transmission(s) after the new UL transmission 502 carrying the PHR may be considered when determining the maximum average percentage of (UL) symbols that may be transmitted in the reference time window 54. For example, at least one configured UL transmission or UL transmissions scheduled by the DCI formats received before the DCI format scheduling the new UL transmission 502 carrying the PHR, or scheduled by the DCI formats received in the same PDCCH monitoring occasion as the DCI format scheduling the new UL transmission 502, may be considered when determining the maximum average percentage of (UL) symbols that may be transmitted in the reference time window 54. In some implementations, if UL skipping is configured, the configured or scheduled UL transmission(s) may be assumed as not to be skipped when determining the maximum average percentage of (UL) symbols that may be transmitted in the reference time window 54.

In some implementations, for determining the maximum average percentage of (UL) symbols that may be transmitted in the reference time window (e.g., the reference time window 54), an assumption may be made regarding the ratio of the UL transmissions in the two frequency bands. This is because the average percentage of the transmitted UL symbols may be defined as 50%×(Duty_{NR,x}/maxDuty_{NR,x}+Duty_{NR,y}/maxDuty_{NR,y}), which may take into account the UL transmissions in the two frequency bands (e.g., the frequency band x and the frequency band y) and the weighting of the UL transmissions in the two frequency bands (e.g., maxDuty_{NR,x} and maxDuty_{NR,y}) may be different. For example, a 1-to-1 ratio of the two frequency bands may be assumed. That is, when determining the maximum average percentage of (UL) symbols that may be transmitted in the reference time window, it may be assumed that the number of (UL) symbols transmitted in the frequency band x is the same as the number of (UL) symbols transmitted in the frequency band y in the reference time window.

In some implementations, if the power state indicated in the PHR is an HPS, the PHR may also indicate a maximum duration during which the UE is in the HPS. This maximum duration may represent a period during which the UE is in the HPS after the end of the new transmission carrying the PHR, assuming that the UL transmissions occur in this period.

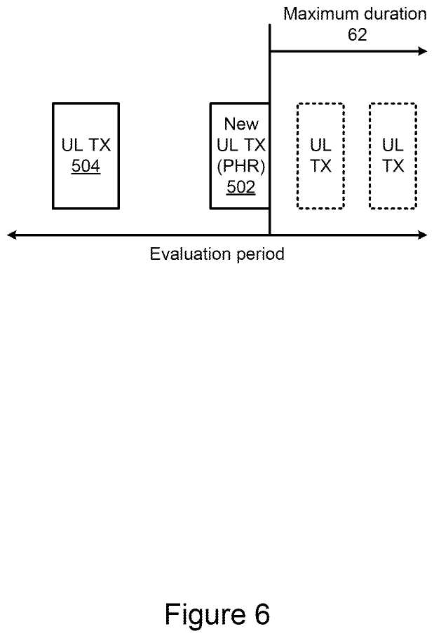

FIG. 6 is a diagram illustrating a maximum duration 62 during which the UE is in a particular power state (e.g., an HPS), according to an example implementation of the present disclosure. As illustrated in FIG. 6, the PHR is carried by the new UL transmission 502 following the UL transmission 504. The maximum duration 62 begins after the end of the new UL transmission 502 carrying the PHR. Since the UE may or may not be scheduled or configured with UL transmissions (e.g., represented by dashed rectangles in FIG. 6) in the maximum duration 62, the UE may still be in the HPS after the end of the indicated duration. Therefore, the UE may report another PHR after the end of the indicated duration.

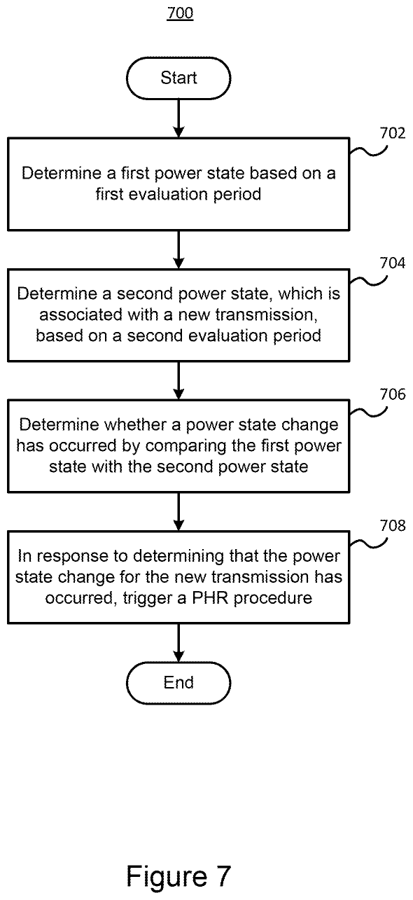

FIG. 7 is a flowchart of a method/process 700 for power control enhancement, according to an example implementation of the present disclosure. It should be noted that although actions 702-708 are illustrated as separate actions that are represented as independent blocks in FIG. 7, these separately illustrated actions should not be construed as necessarily order-dependent. The order in which the actions are performed in FIG. 7 is not intended to be construed as a limitation, and any number of the disclosed blocks may be combined in any order to implement the method, or an alternative method. Moreover, each of actions 702, 704, 706, and 708 may be performed independently of other actions and may be omitted in some implementations of the present disclosure.

Process 700 may start by determining, in action 702, a first power state based on a first evaluation period.

In action 704, the UE may determine a second power state, which is associated with a new transmission, based on a second evaluation period.

In action 706, the UE may determine whether a power state change has occurred by comparing the first power state with the second power state.

In action 708, in response to determining that the power state change for the new transmission has occurred, the UE may trigger a PHR procedure. In some implementations, the UE may trigger the PHR procedure based on one or more of the mechanisms 1, 2, and/or 3, as described above. The process may then end.

In some implementations, the UE may transmit, to a BS, an indication (e.g., through an IE, such as the highPowerLimit-r17 IE) indicating that the UE supports transmissions under a CA architecture across different frequency bands with different power classes. In some implementations, the transmission of the indication may occur before action 702.

In some implementations, the UE may transmit, to a BS, an indication (e.g., through an IE, such as the maxUplinkDutyCycle-interBand (′A-PC2 IE) indicating a maximum average percentage of (UL) symbols, during a UL duty cycle, that are permitted to be scheduled for a UL transmission at an increased power. In some implementations, the transmission of the indication may occur before action 702.

In some implementations, the UE may transmit a PHR using the new transmission in response to triggering the PHR procedure (in action 708), and start a prohibit timer (e.g., using a timer, such as the phr-ProhibitTimerr, or another predetermined timer) in response to transmitting the PHR. The UE may be prohibited from transmitting another PHR while the prohibit timer is running.

In some implementations, the UE may receive, from a BS, an indication indicating that the UE is allowed to trigger the PHR procedure in response to a power state change. That is, the BS may configure the UE, such that the UE may be allowed to trigger the PHR procedure based on the power state change. In some implementations, the reception of the indication may occur before action 702.

In some implementations, the first evaluation period may include one or more first UL transmissions prior to the new transmission, and the second evaluation period may include the new transmission. For example, as illustrated in FIG. 2, the evaluation period 22 may include the UL transmissions 202, 204, 206, and 208 which may occur prior to the new (UL) transmission 210. The evaluation period 24 may include the new (UL) transmission 210 carrying the PHR.

In some implementations, the first evaluation period may further include a second UL transmission after the new transmission.

In some implementations, the UE may receive, for example, in a PDCCH monitoring occasion, a first DCI format that schedules the new transmission, and may receive, in the same PDCCH monitoring occasion, a second DCI format that schedules the second UL transmission. For example, as illustrated in FIG. 3, the DCI format 302 may schedule the UL transmission 306, which is a new transmission, and the DCI format 304, received in the same PDCCH monitoring occasion, as the DCI format 302, may schedule another UL transmission 308 that occurs after the UL transmission 306. The UE may use the UL transmission 306 to transmit the PHR, once the PHR procedure is triggered due to the power state change.

The method 700 introduces a new PHR triggering mechanism based on the power state changes. It enhances network efficiency with dynamic power management, optimizing the UE's power usage and improving resource allocation, thus enhancing the network performance.

It should be noted that in the present disclosure, the BS may perform methods/actions corresponding to those performed by the UE. For example, the receiving actions performed by the UE may correspond to the transmitting/configuring actions of the BS, and the transmitting actions performed by the UE may correspond to the receiving actions of the BS. That is, the BS and the UE may have reciprocally aligned roles in transmission and reception. Furthermore, for certain operations, both the UE and the BS may have a mutual understanding of the timer operations. For example, the BS may anticipate, expect, or determine when the UE starts a timer and when the timer is expected to expire or stop. This synchronized understanding allows for coordinated actions, ensuring that the network and the UE are in sync for critical operations, such as a handover or a reconfiguration. Additionally, signaling sent from the BS to the UE may serve as a trigger condition that enables or causes the UE to execute steps/actions of a method, such as method 700, as described above. This means that the BS's instructions through signaling may directly influence the UE's behavior, enabling the UE to initiate specific processes or actions in response.

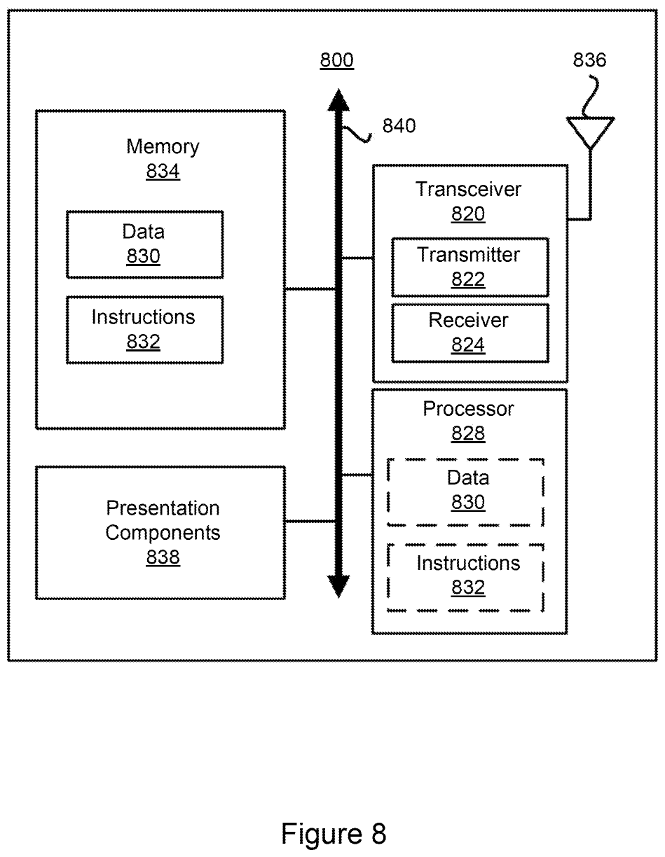

FIG. 8 is a block diagram illustrating node 800 for wireless communication in accordance with various aspects of the present disclosure. As illustrated in FIG. 8, node 800 may include transceiver 820, processor 828, memory 834, one or more presentation components 838, and at least one antenna 836. Node 800 may also include a radio frequency (RF) spectrum band module, a BS communications module, a network communications module, and a system communications management module, Input/Output (I/O) ports, I/O components, and a power supply (not illustrated in FIG. 8).

Each of the components may directly or indirectly communicate with each other over one or more buses 840. Node 800 may be a UE or a BS that performs various functions disclosed with reference to FIGS. 1 through 7.

Transceiver 820 has transmitter 822 (e.g., transmitting/transmission circuitry) and receiver 824 (e.g., receiving/reception circuitry) and may be configured to transmit and/or receive time and/or frequency resource partitioning information. Transceiver 820 may be configured to transmit in different types of subframes and slots including, but not limited to, usable, non-usable, and flexibly usable subframes and slot formats. Transceiver 820 may be configured to receive data and control channels.

Node 800 may include a variety of computer-readable media. Computer-readable media may be any available media that may be accessed by node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above-listed components should also be included within the scope of computer-readable media.

Memory 834 may include computer-storage media in the form of volatile and/or non-volatile memory. Memory 834 may be removable, non-removable, or a combination thereof. Example memory may include solid-state memory, hard drives, optical-disc drives, etc. As illustrated in FIG. 8, memory 834 may store a computer-readable and/or computer-executable instructions 832 (e.g., software codes) that are configured to, when executed, cause processor 828 to perform various functions disclosed herein, for example, with reference to FIGS. 1 through 7. Alternatively, instructions 832 may not be directly executable by processor 828 but may be configured to cause node 800 (e.g., when compiled and executed) to perform various functions disclosed herein.

Processor 828 (e.g., having processing circuitry) may include an intelligent hardware device, e.g., a Central Processing Unit (CPU), a microcontroller, an ASIC, etc. Processor 828 may include memory. Processor 828 may process data 830 and instructions 832 received from memory 834, and information transmitted and received via transceiver 820, the baseband communications module, and/or the network communications module. Processor 828 may also process information to send to transceiver 820 for transmission via antenna 836 to the network communications module for transmission to a CN.

One or more presentation components 838 may present data indications to a person or another device. Examples of presentation components 838 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for power control enhancement, the method comprising:
determining a first power state based on a first evaluation period;
determining a second power state, which is associated with a new transmission, based on a second evaluation period;
determining whether a power state change has occurred by comparing the first power state with the second power state; and
in response to determining that the power state change for the new transmission has occurred, triggering a Power Headroom Report (PHR) procedure.

2. The method of claim 1, further comprising:
transmitting, to a Base Station (BS), an indication indicating that the UE supports transmissions under a Carrier Aggregation (CA) architecture across different frequency bands with different power classes.

3. The method of claim 1, further comprising:
transmitting, to a Base Station (BS), an indication indicating a maximum average percentage of symbols, during an Uplink (UL) duty cycle, that are permitted to be scheduled for a UL transmission at an increased power.

4. The method of claim 1, further comprising:
transmitting a PHR using the new transmission in response to triggering the PHR procedure; and
starting a prohibit timer in response to transmitting the PHR,
wherein the UE is prohibited from transmitting another PHR while the prohibit timer is running.

5. The method of claim 1, further comprising:
receiving, from a Base Station (BS), an indication indicating that the UE is allowed to trigger the PHR procedure in response to determining that the power state change has occurred.

6. The method of claim 1, wherein:
the first evaluation period includes one or more first Uplink (UL) transmissions prior to the new transmission, and
the second evaluation period includes the new transmission.

7. The method of claim 6, wherein the first evaluation period further includes a second UL transmission after the new transmission.

8. The method of claim 7, further comprising:
receiving, in a Physical Downlink Control Channel (PDCCH) monitoring occasion, a first Downlink Control Information (DCI) format that schedules the new transmission; and
receiving, in the same PDCCH monitoring occasion, a second DCI format that schedules the second UL transmission.

9. A User Equipment (UE) for power control enhancement, the UE comprising:
at least one processor; and
at least one non-transitory computer-readable medium coupled to the at least one processor and storing one or more computer-executable instructions that, when executed by the at least one processor, cause the UE to:
determine a first power state based on a first evaluation period;
determine a second power state, which is associated with a new transmission, based on a second evaluation period;
determine whether a power state change has occurred by comparing the first power state with the second power state; and
in response to determining that the power state change for the new transmission has occurred, trigger a Power Headroom Report (PHR) procedure.

10. The UE of claim 9, wherein the one or more computer-executable instructions, when executed by the at least one processor, further cause the UE to:
transmit, to a Base Station (BS), an indication indicating that the UE supports transmissions under a Carrier Aggregation (CA) architecture across different frequency bands with different power classes.

11. The UE of claim 9, wherein the one or more computer-executable instructions, when executed by the at least one processor, further cause the UE to:
transmit, to a Base Station (BS), an indication indicating a maximum average percentage of symbols, during an Uplink (UL) duty cycle, that are permitted to be scheduled for a UL transmission at an increased power.

12. The UE of claim 9, wherein the one or more computer-executable instructions, when executed by the at least one processor, further cause the UE to:
transmit a PHR using the new transmission in response to triggering the PHR procedure; and
start a prohibit timer in response to transmitting the PHR,
wherein the UE is prohibited from transmitting another PHR while the prohibit timer is running.

13. The UE of claim 9, wherein the one or more computer-executable instructions, when executed by the at least one processor, further cause the UE to:
receive, from a Base Station (BS), an indication indicating that the UE is allowed to trigger the PHR procedure in response to determining that the power state change has occurred.

14. The UE of claim 9, wherein:
the first evaluation period includes one or more first Uplink (UL) transmissions prior to the new transmission, and
the second evaluation period includes the new transmission.

15. The UE of claim 14, wherein the first evaluation period further includes a second UL transmission after the new transmission.

16. The UE of claim 15, wherein the one or more computer-executable instructions, when executed by the at least one processor, further cause the UE to:
receive, in a Physical Downlink Control Channel (PDCCH) monitoring occasion, a first Downlink Control Information (DCI) format that schedules the new transmission; and
receive, in the same PDCCH monitoring occasion, a second DCI format that schedules the second UL transmission.
